(19) United States
(12) Patent Application Publication
(10) Pub. No.: US 2021/0217118 A1
(43) Pub. Date: Jul. 15, 2021

(54) PRESENTATION DEVICE, PRESENTATION METHOD, AND PRESENTATION PROGRAM

(71) Applicant: NIPPON TELEGRAPH AND TELEPHONE CORPORATION, Tokyo (JP)

(72) Inventors: Tomohiro KOKOGAWA, Musashino-shi, Tokyo (JP); Megumi UESU, Musashino-shi, Tokyo (JP); Naoko KOSAKA, Musashino-shi, Tokyo (JP)

(73) Assignee: NIPPON TELEGRAPH AND TELEPHONE CORPORATION, Tokyo (JP)

(21) Appl. No.: 17/056,420

(22) PCT Filed: May 31, 2019
(86) PCT No.: PCT/JP2019/021763

§ 371 Date: Nov. 18, 2020

(30) Foreign Application Priority Data
Jun. 1, 2018 (JP) 2018-106462

(51) Int. Cl. G06Q 50/26; G06Q 10/06

(52) U.S. Cl. CPC G06Q 50/26; G06Q 10/0635

(57) ABSTRACT

A collecting unit (11) of a presentation apparatus (10) collects information that is information regarding crisis management and is associated with each of a plurality of information sources (20), from the plurality of information sources (20). A supplementing unit (15) supplements information not collected by the collecting unit (11), in the information. An estimating unit (14) estimates a risk of a crisis, based on the information collected by the collecting unit (11) and the information supplemented by the supplementing unit (15). A calculating unit (13) calculates a reliability level of a risk estimated by the estimating unit (14), based on a level of supplementation by the supplementing unit (15). A presenting unit (17) presents the risk estimated by the estimating unit (14), together with the reliability level calculated by the calculating unit (13).

### TECHNICAL FIELD

The present invention relates to a presentation apparatus, a presentation method, and a presentation program.

### BACKGROUND ART

Conventionally, organizations that deal with crises such as natural disasters and cyberattacks have known techniques for estimating risks through analyses and simulations using external information available from an information source that is outside an own organization and internal information held by the own organization. Examples of the external information include weather information, geographical information, cyberattack information, and the like available from government agencies or the like.

### CITATION LIST

### Non Patent Literature

[NPL 1] Disaster Information Systems of Cabinet Office, Government of Japan, [online], [accessed on May 25, 2018], the Internet

(http://www.bousai.go.jp/kazan/kakonotaisaku/sinkasai/s308.htm)

### SUMMARY OF THE INVENTION

### Technical Problem

However, conventional techniques are problematic in that it may be difficult to properly present an estimated risk. When a crisis occurs, the level of precision in estimating a risk may be lowered due to difficulty of collecting information and the like. According to conventional techniques, it may be difficult to properly present a risk estimated in such a situation.

It is conceivable that the level of precision in estimating a risk is lowered by various factors. For example, when a large-scale crisis occurs, while it is difficult to collect necessary information, it is necessary to estimate a risk and make a speedy decision. At that time, regarding insufficient information, it is conceivable to perform estimation based on assumptions given in advance or previous experiences, but it is difficult to precisely perform estimation when people lack experience or in a mental state in which they are likely to be in a panic. Furthermore, for example, if parameter that are to be input to computer simulations for estimating a risk of disasters are not correctly obtained, the estimation result may be significantly different from the actual state.

### Means for Solving the Problem

In order to solve the above-described problems and attain an object, a presentation apparatus includes: a collecting unit that collects information that is information regarding crisis management and is associated with each of a plurality of information sources, from the plurality of information sources; a supplementing unit that supplements information not collected by the collecting unit, in the information; an estimating unit that estimates a risk of a crisis, based on the information collected by the collecting unit and the information supplemented by the supplementing unit; a calculating unit that calculates a reliability level of a risk estimated by the estimating unit, based on a level of supplementation by the supplementing unit; and a presenting unit that presents the risk estimated by the estimating unit, together with the reliability level calculated by the calculating unit.

### EFFECTS OF THE INVENTION

According to the present invention, it is possible to properly present an estimated risk.

### BRIEF DESCRIPTION OF DRAWINGS

FIG. 1 is a diagram showing an example of the configuration of a presentation apparatus according to a first embodiment.

FIG. 2 is a table showing an example of information sources and information according to the first embodiment.

FIG. 3 is a table showing an example of contribution rates according to the first embodiment.

FIG. 4 is a sequence diagram illustrating the processing and information flow of the presentation apparatus according to the first embodiment.

FIG. 5 is a flowchart illustrating the processing flow of the presentation apparatus according to the first embodiment.

FIG. 6 is a diagram showing an example of a computer for executing a presentation program.

### DESCRIPTION OF EMBODIMENTS

Hereinafter, embodiments of a presentation apparatus, a presentation method, and a presentation program according to the present application will be described in detail with reference to the drawings. Note that the present invention is not limited by the embodiments described below.

### CONFIGURATION OF FIRST EMBODIMENT

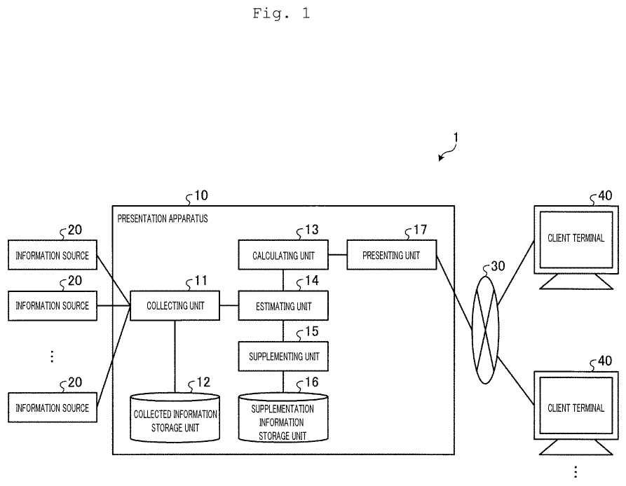

First, the configuration of a presentation apparatus according to the first embodiment will be described with reference to FIG. 1. FIG. 1 is a diagram showing an example of the configuration of the presentation apparatus according to the first embodiment. As shown in FIG. 1, a presentation apparatus 10 is included in a presentation system 1. Furthermore, the presentation system 1 has the presentation apparatus 10, information sources 20, a network 30, and client terminals 40.

The information sources 20 provide the presentation apparatus 10 with information regarding crisis management. For example, the information sources 20 are servers that are used to store and provide information, in government agencies, local governments, fire departments, and the like. The information sources 20 may transmit information to the presentation apparatus 10 in response to a request, or may automatically transmit information to the presentation apparatus 10 at a predetermined time.

The client terminals 40 are connected to the presentation apparatus 10 via the network 30. The client terminals 40 are information terminals that are used in departments such as local governments that deal with disasters. For example, the client terminals 40 are personal computers and smartphones.

The presentation apparatus 10 estimates a risk based on the information collected from the information sources 20, and presents the estimated risk to the client terminals 40. At that time, the presentation apparatus 10 presents a reliability level of the information, together with the estimated risk. Furthermore, the presentation apparatus 10 has a collecting unit 11, a collected information storage unit 12, a calculating unit 13, an estimating unit 14, a supplementing unit 15, a supplementation information storage unit 16, and a presenting unit 17.

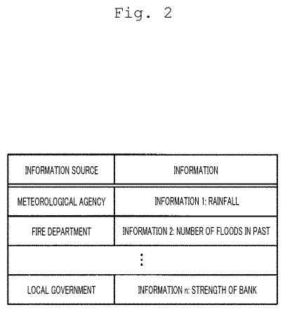

The collecting unit 11 collects information that is information regarding crisis management and is associated with each of the plurality of information sources 20, from the plurality of information sources 20. As shown in FIG. 2, information with which the presentation apparatus 10 is to be provided is associated with each of the information sources 20. FIG. 2 is a table showing an example of information sources and information according to the first embodiment.

For example, as shown in FIG. 2, the information sources 20 include “meteorological agency”, “fire department”, and “local government”. Furthermore, in this embodiment, the number of information sources 20 is taken as n, and information associated with a k^{-th} information source is indicated as “information k”.

As shown in FIG. 2, “meteorological agency”, which is a first information source 20, is associated with “information 1: rainfall”. Furthermore, “fire department”, which is a second information source 20, is associated with “information 2: number of floods in past”. Furthermore, “local government”, which is an n^{-th} information source 20, is associated with “information n: strength of bank”.

For example, the collecting unit 11 transmits a message requesting that a predetermined server used by each information source 20 transmit information, and receives information transmitted from the server. At this time, there is a case in which the collecting unit 11 cannot collect information due to various circumstances of each information source 20. That is to say, missing of information may occur.

For example, if a sufficient period of time has not elapsed from when a disaster occurred, it is conceivable that the information sources 20 have not yet obtained information that can be provided. Furthermore, it is conceivable that information communication environments are damaged by the disaster and the like, and information cannot be transmitted or received between the information sources 20 and the presentation apparatus 10.

Furthermore, the collecting unit 11 stores collected information in the collected information storage unit 12. Note that information stored in the collected information storage unit 12 can be referred to by the estimating unit 14, the supplementing unit 15, and the like. Furthermore, the collecting unit 11 may directly deliver collected information to the estimating unit 14.

The estimating unit 14 estimate a risk based on the information collected by the collecting unit 11. For example, the estimating unit 14 can estimate, as a risk, an estimated time until a river flood occurs due to heavy rain. In addition, the estimating unit 14 can estimate the number of sufferers and damaged houses due to natural disasters, the number of terminals under cyberattacks, and the like.

Furthermore, if part of the information collected by the collecting unit 11 is missing, the estimating unit 14 performs estimation using the information supplemented by the supplementing unit 15. That is to say, the estimating unit 14 estimates a risk of a crisis, based on the information collected by the collecting unit 11 and the information supplemented by the supplementing unit 15.

The supplementing unit 15 supplements information not collected by the collecting unit 11, in the information. The supplementing unit 15 supplements missing information. The supplementing unit 15 supplements information while referring to the supplementation information storage unit 16. For example, estimated values in damage prediction estimated in advance are stored in the supplementation information storage unit 16.

For example, the presentation apparatus 10 may regularly calculate rainfall in a certain period of time from rainfall in the past, for damage prediction, and store it in the supplementation information storage unit 16. At this time, if the collecting unit 11 cannot collect rainfall, the supplementing unit 15 can acquire the rainfall from the supplementation information storage unit 16, thereby supplementing information. Furthermore, the supplementing unit 15 can supplement missing information not only as a value but also as a range. For example, the supplementing unit 15 may supplement supplementation information of rainfall as “25 mm” or as “20 to 30 mm”.

If information has been supplemented by the supplementing unit 15, the estimating unit 14 can estimate a risk regardless of whether or not information is missing. Note that, if information has been supplemented, it is conceivable that the level of precision at which the estimating unit 14 estimates a risk decreases compared with a case in which no piece of information is missing. Moreover, the higher the level of supplementation is, the more the level of precision at which the estimating unit 14 estimates a risk decreases.

Thus, the calculating unit 13 calculates a reliability level of the risk estimated by the estimating unit 14, based on the level of supplementation by the supplementing unit 15. Note that the level of supplementation is, for example, the number of pieces of supplementation information, the contribution rate of supplementation information in risk estimating calculation, or the like. Furthermore, the presenting unit 17 presents the risk estimated by the estimating unit 14, together with the reliability level calculated by the calculating unit 13.

### (Method for Calculating Reliability Level Using Contribution Rate)

Hereinafter, a method in which the calculating unit 13 calculates a reliability level and a method in which the presenting unit 17 performs presentation will be described by way of specific examples. First, the calculating unit 13 can calculate a reliability level, based on a contribution rate of risk estimation by the estimating unit 14, the contribution rate being set for each piece of information collected by the collecting unit 11.

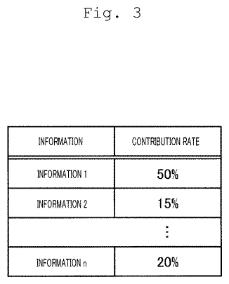

In this case, as shown in FIG. 3, it is assumed that a contribution rate is set in advance for each piece of information. In the example of FIG. 3, the contribution rate of “information 1” is set to “50%”. Furthermore, the contribution rate of “information 2” is set to “15%”. Furthermore, the contribution rate of “information 3” is set to “20%”. Note that the reliability levels of respective pieces of information may be different or the same.

The contribution rate may be a value according to a calculation model used by the calculating unit 13. For example, if the calculating unit 13 calculates a reliability level by weighting each piece of information as a coefficient, the contribution rate may be a value that is proportional to the coefficient. Furthermore, the contribution rate of information from an information source 20 that is known to have a high reliability level from experience and information that is highly influential to crisis management is set to be high.

The calculating unit 13 calculates a reliability level as “1−(total contribution rate of supplementation information)”. For example, in the example of FIG. 3, if only the information n is missing, the calculating unit 13 calculates a reliability level as 1−0.2=0.8 because the contribution rate of the information n is 20%. Furthermore, in the example of FIG. 3, if only the information 2 and the information n are missing, the calculating unit 13 calculates a reliability level as 1−(0.15+0.2)=0.65 because the contribution rates of the information 2 and the information n are 15% and 20%.

Furthermore, in this case, the presenting unit 17 can present information “X area may be flooded due to a river flood after 3 hours. Note that the reliability level is 65% because the information 2 and the information n are unavailable”.

### (Method for Calculating Reliability Level Using Largest Value and Smallest Value)

As described above, the supplementing unit 15 can supplement the largest value and the smallest value of information not collected by the collecting unit 11. At this time, the calculating unit 13 calculates a reliability level, based on the variation range between a risk estimated by the estimating unit 14 based on the largest value and a risk estimated by the estimating unit 14 based on the smallest value.

It is assumed that the supplementing unit 15 supplements the missing information as a range, and the largest value of the range is X1 and the smallest value thereof is X2. Furthermore, it is assumed that the estimated value of a risk estimated by the estimating unit 14 when the missing information is taken as X1 is R1. Furthermore, it is assumed that the estimated value of a risk estimated by the estimating unit 14 when the missing information is taken as X2 is R2.

At this time, the calculating unit 13 calculates an estimated value of the risk that is to be presented as “(R1+R2)/2”. Furthermore, the calculating unit 13 calculates a reliability level as “1−(R1−R2)/(R1+R2)”.

For example, it is assumed that “information 1: rainfall” in FIG. 2 is missing and the supplementing unit 15 supplements the rainfall as “20 to 30 mm”. In this case, X1 and X2 are respectively 30 mm and 20 mm. Furthermore, it is assumed that, at this time, the times R1 and R2 taken until a river flood occurs as estimated by the estimating unit 14 are respectively 3.3 hours and 2.7 hours.

In this case, the calculating unit 13 calculates an estimated value of the risk that is to be presented as “(3.3+2.7)/2=3”. Furthermore, the calculating unit 13 calculates a reliability level as “1−(3.3−2.7)/(3.3+2.7)=0.9”.

Furthermore, in this case, the presenting unit 17 can present information “X area may be flooded due to a river flood after 3 hours. Note that the flood estimated time may vary by 10% (reliability level 90%) because the information 1 is unavailable”.

### Processing of First Embodiment

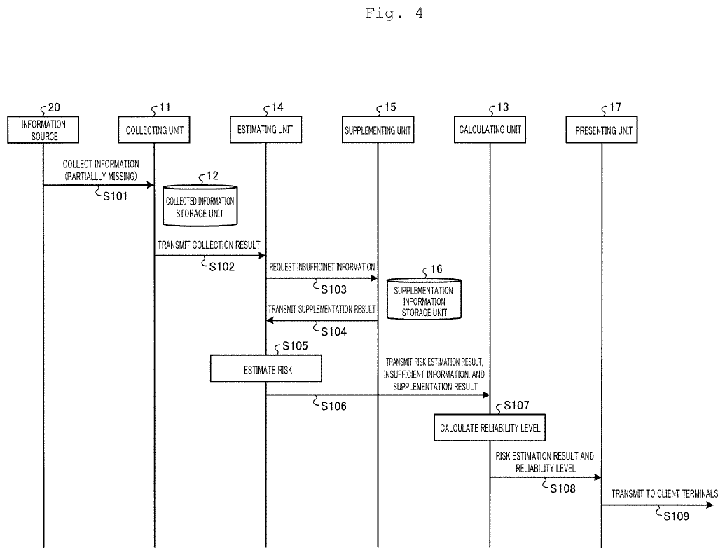

Hereinafter, processing and information exchange of the units of the presentation apparatus 10 will be described with reference to FIG. 4. FIG. 4 is a sequence diagram illustrating the processing and information flow of the presentation apparatus according to the first embodiment. As shown in FIG. 4, the collecting unit 11 collects information from the information sources 20, and stores the collected information in the collected information storage unit 12 (step S101).

The collecting unit 11 transmits a collection result to the estimating unit 14 (step S102). The estimating unit 14 requests the supplementing unit 15 for insufficient information, which is information regarding missing information (step S103). The supplementing unit 15 supplements information while referring to the information stored in the supplementation information storage unit 16, and transmits a supplementation result to the estimating unit 14 (step S104).

The estimating unit 14 estimates a risk based on the supplementation result (step S105). Then, the estimating unit 14 transmits the risk estimation result, the insufficient information, and the supplementation information to the calculating unit 13 (step S106).

The calculating unit 13 calculates a reliability level (step S107). Then, the calculating unit 13 transmits the risk estimation result and the reliability level to the presenting unit 17 (step S108). The presenting unit 17 transmits the risk estimation result and the reliability level to client terminals (step S109).

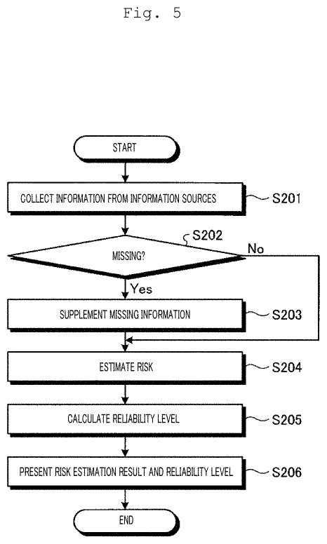

Next, the processing flow of the presentation apparatus 10 will be described with reference to FIG. 5. FIG. 5 is a flowchart illustrating the processing flow of the presentation apparatus according to the first embodiment. As shown in FIG. 5, the presentation apparatus 10 collects information from the information sources 20 (step S201).

If there is missing information in the collected information (Yes in step S202), the presentation apparatus 10 supplements the missing information (step S203). On the other hand, there is no missing information in the collected information (No in step S202), the presentation apparatus 10 advances to the next processing without supplementing missing information.

Next, the presentation apparatus 10 estimates a risk based on the collected information and the supplementation information (step S204). Then, the presentation apparatus 10 calculates a reliability level of the estimated risk based on the level of supplementation (step S205). Subsequently, the presentation apparatus 10 presents the risk estimation result and the reliability level via the client terminals 40 (step S206).

### Effects of First Embodiment

In the first embodiment, the collecting unit 11 of the presentation apparatus 10 collects information that is information regarding crisis management and is associated with each of the plurality of information sources 20, from the plurality of information sources 20. Furthermore, the supplementing unit 15 supplements information not collected by the collecting unit 11, in the information. Furthermore, the estimating unit 14 estimates a risk of a crisis, based on the information collected by the collecting unit 11 and the information supplemented by the supplementing unit 15. Furthermore, the calculating unit 13 calculates a reliability level of the risk estimated by the estimating unit 14, based on the level of supplementation by the supplementing unit 15. Furthermore, the presenting unit 17 presents the risk estimated by the estimating unit 14, together with the reliability level calculated by the calculating unit 13. In this manner, according to this embodiment, the presentation apparatus 10 can present a reliability level of a risk estimation result according to an information supplementation level. Accordingly, even in the case in which information cannot be sufficiently collected, the presentation apparatus 10 can properly present an estimated risk.

The calculating unit 13 can calculate a reliability level, based on a contribution rate of risk estimation by the estimating unit 14, the contribution rate being set for each piece of information collected by the collecting unit 11. Accordingly, the presentation apparatus 10 can calculate a reliability level according to missing information.

The supplementing unit 15 can supplement the largest value and the smallest value of information not collected by the collecting unit 11. At this time, the calculating unit 13 calculates a reliability level, based on the variation range between a risk estimated by the estimating unit 14 based on the largest value and a risk estimated by the estimating unit 14 based on the smallest value. Accordingly, the presentation apparatus 10 can present an estimation result in consideration of the variation range.

### System Configuration, etc.

The constituent elements of the devices illustrated in the drawings are functionally conceptual, and are not necessarily configured physically as illustrated in the drawings. That is, specific modes of distribution and integration of the devices are not limited to those illustrated in the drawings, and all or part of the devices can be configured while being functionally or physically distributed or integrated in any unit according to various types of loads, use status, and the like. Further, all or any part of the processing functions executed in the devices can be realized by a CPU and a program analyzed and executed in the CPU, or can be realized as hardware by a wired logic.

Of the various types of processing described in the embodiments of the present invention, all or part of each processing described as being performed automatically may be performed manually, or all or part of each processing described as being performed manually may be automatically performed by a known method. In addition, the processing procedures, control procedures, specific names, information containing various types of data and parameters described in the above document and drawings may be changed freely unless otherwise specified.

### Program

In an embodiment, the presentation apparatus 10 can be implemented by installing, on a desired computer, a presentation program executing the above-described information presentation as package software or online software. For example, by causing an information processing device to execute the above-described presentation program, the information processing device can function as the presentation apparatus 10. The information processing device as mentioned herein includes a desktop or notebook personal computer. In addition, a mobile communication terminal such as a smartphone, a mobile phone, and a personal handy-phone system (PHS), and also a slate terminal such as a personal digital assistant (PDA) fall under the category of the information processing device.

The presentation apparatus 10 can also be implemented as a presentation server apparatus that, with a terminal apparatus used by a user set as a client, provides a service relating to the above-described information presentation to the client. For example, the presentation server apparatus is implemented as a server apparatus that provides a presentation service in which collected information is used as input and a risk estimation result and a reliability level are used as output. In this case, the presentation server apparatus may also be implemented as a Web server, and may also be implemented as a cloud providing a service relating to the above-described information presentation through outsourcing.

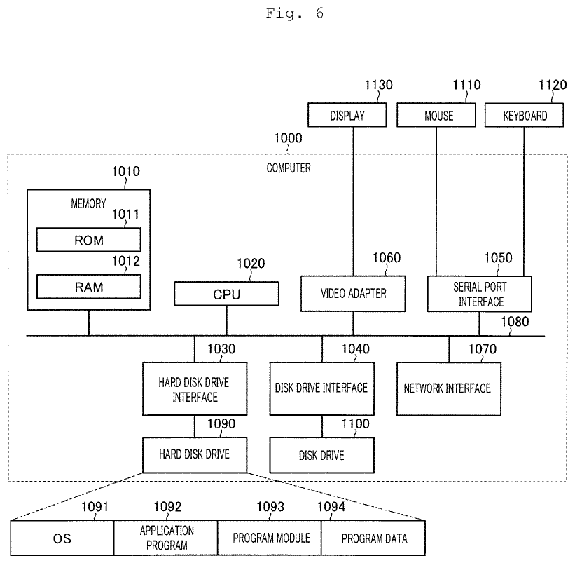

FIG. 6 is a diagram showing an example of a computer that executes the presentation program. A computer 1000 includes a memory 1010 and a CPU 1020, for example. Also, the computer 1000 includes a hard disk drive interface 1030, a disk drive interface 1040, a serial port interface 1050, a video adapter 1060, and a network interface 1070. Each of these units is connected by a bus 1080.

The memory 1010 includes a read only memory (ROM) 1011 and a RAM 1012. The ROM 1011 stores a boot program such as a basic input output system (BIOS), for example. The hard disk drive interface 1030 is connected to a hard disk drive 1090. The disk drive interface 1040 is connected to a disk drive 1100. For example, a removable storage medium such as a magnetic disk and an optical disk is inserted into the disk drive 1100. The serial port interface 1050 is connected to a mouse 1110 and a keyboard 1120, for example. The video adapter 1060 is connected to a display 1130, for example.

The hard disk drive 1090 stores an OS 1091, an application program 1092, a program module 1093, and program data 1094, for example. That is, the program specifying various types of processing of the presentation apparatus 10 is implemented as a program module 1093 in which a computer-executable code is written. The program module 1093 is stored in the hard disk drive 1090, for example. For example, a program module 1093 for executing the same processing as the functional configuration in the presentation apparatus 10 is stored in the hard disk drive 1090. Note that the hard disk drive 1090 may be replaced with an SSD.

The setting data used in the processing of the embodiment described above is stored, as the program data 1094, in the memory 1010 or the hard disk drive 1090, for example. Then, the CPU 1020 reads the program module 1093 and the program data 1094 stored in the memory 1010 or the hard disk drive 1090 to the RAM 1012 as needed, and executes the processing of the embodiment described above.

Note that the program module 1093 and the program data 1094 are not necessarily stored in the hard disk drive 1090, and may be stored in a removable storage medium, for example, and read by the CPU 1020 via the disk drive 1100 or the like. Alternatively, the program module 1093 and the program data 1094 may be stored in another computer connected via a network (e.g., a local area network (LAN) or a wide area network (WAN)). Then, the program module 1093 and the program data 1094 may be read from the other computer by the CPU 1020 via the network interface 1070.

### REFERENCE SIGNS LIST

10 Presentation apparatus

11 Collecting unit

12 Collected information storage unit

13 Calculating unit

14 Estimating unit

15 Supplementing unit

16 Supplementation information storage unit

17 Presenting unit

20 Information source

30 Network

40 Client terminal

1. A presentation apparatus comprising: a collecting unit that collects information that is information regarding crisis management and is associated with each of a plurality of information sources, from the plurality of information sources; a supplementing unit that supplements information not collected by the collecting unit, in the information; an estimating unit that estimates a risk of a crisis, based on the information collected by the collecting unit and the information supplemented by the supplementing unit; a calculating unit that calculates a reliability level of a risk estimated by the estimating unit, based on a level of supplementation by the supplementing unit; and a presenting unit that presents the risk estimated by the estimating unit, together with the reliability level calculated by the calculating unit.

2. The presentation apparatus according to claim 1, wherein the calculating unit calculates the reliability level, based on a contribution rate of risk estimation by the estimating unit, the contribution rate being set for each piece of the information collected by the collecting unit.

3. The presentation apparatus according to claim 1, wherein the supplementing unit supplements a largest value and a smallest value of information not collected by the collecting unit, and the calculating unit calculates the reliability level, based on a variation range between a risk estimated by the estimating unit based on the largest value and a risk estimated by the estimating unit based on the smallest value.

4. A computer-implemented presentation method comprising: a collecting step of collecting information that is information regarding crisis management and is associated with each of a plurality of information sources, from the plurality of information sources; a supplementing step of supplementing information not collected in the collecting step, in the information; an estimating step of estimating a risk of a crisis, based on the information collected in the collecting step and the information supplemented in the supplementing step; a calculating step of calculating a reliability level of a risk estimated in the estimating step, based on a level of supplementation in the supplementing step; and a presenting step of presenting the risk estimated in the estimating step, together with the reliability level calculated in the calculating step.

5. A presentation program for causing a computer to function as the presentation apparatus according to claim 1.
